(19) United States
(12) Patent Application Publication
(10) Pub. No.: US 2003/0136494 A1
(43) Pub. Date: Jul. 24, 2003

(54) Floor plank and method of manufacturing it

(76) Inventors: Ulrich Windmoller, Stukenbrock (DE); Volker Kettler, Werther (DE)

Correspondence Address: STEVENS, DAVIS, MILLER & MOSHER, L.L.P., 1615 L Street, N.W., Suite 850, Washington, DC, 20036, US

(21) Appl. No.: 10/051,461

(22) Filed: Jan. 22, 2002

(30) Foreign Application Priority Data
Jan. 22, 2002 (DE) 101 02 790.7

(51) Int. Cl. B32B 17/00

(52) U.S. Cl. 156/62.2; 156/71; 428/546; 428/323

(57) ABSTRACT

A floor plank, especially a multi-layer, pressed laminate panel, comprises a decorative paper (12) in the top walked-on layer, which is impregnated with an aminoplastic resin or similar. Particles of an electrically conducting material are applied to the back of the decorative paper (12).

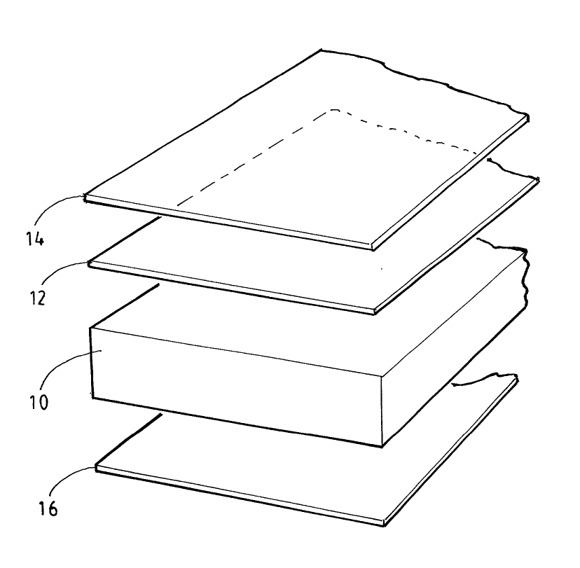

In a method for manufacturing a floor plank, in particular a multi-layer laminate panel pressed together in one operation, which is provided with a decorative paper (12) as the top walked-on layer, which is impregnated with an aminoplastic resin, particles of an electrically conducting material are applied to the back of the decorative paper (12) impregnated with a melamine resin.

This invention relates to a floor plank, in particular a multi-layer pressed laminate panel with a decorative paper in the top walked-on layer, which is impregnated with an aminoplastic resin or similar, and a method of manufacturing such a floor plank.

Floor planks of this type are disclosed in numerous embodiments. Examples are described in U.S. Pat. No. 4,426,820, GB 2256023 A or EP 0 698 162 B1. Laminate floorings of this type tend to accumulate an electrostatic charge. Tests according to ISO 1815 have shown that voltages of up to 5.5 kV can occur. The human body can absorb voltages of up to 2 kV. Higher voltages are experienced as an electric shock.

The existing solutions aimed at suppressing voltages like these relate in particular to double floors for computer rooms. Double floors such as these have melamine resin coated surfaces, and are pressed as high-pressure laminates with several sheets of graphite-impregnated kraft paper behind a decorative layer. With the kind of laminate floors of interest here, however, which are manufactured using the direct coating method, all the layers, including the decorative layer, have to be pressed onto a support in one operation, without additional adhesive. This technology does not allow layers of kraft paper to be integrated behind the decorative layer in one operation without additional adhesive.

This invention is therefore based on the task of creating a floor plank of the above type which enables electrostatic charges to be limited as far as possible, especially to values below 2 kV.

With a floor plank of the above type, this task is solved according to the invention in that particles of an electrically conducting material are applied to the back of the decorative paper.

With most laminate floorings, the top or walked-on side of the resin-soaked impregnated decorative paper is covered by a special transparent cellulose paper. Attempts to impregnate this cellulose layer, which is generally referred to as overlay, with electrically dissipating resins have not been successful. In particular, the transparency of the cellulose layer is negatively affected, i.e. there is unacceptable milky clouding. Such problems do not occur when conducting particles are applied to the back of the decorative paper in line with the invention.

Suitable electrically conducting materials include e.g. iron powder or, especially, graphite dust. Particles of other electrically conducting materials, especially of other metals, can, however, also be used.

The term particle is to be understood in a very broad sense. In addition to the previously mentioned powders and dusts, fine granulates, filings and fibres are also suitable, i.e. all forms of particles able to be distributed over a surface in a largely even manner. Basically, any conducting material is suitable, so that iron powders and graphite dusts are preferable from an economic point of view, but are by no means the only workable solution. As alternatives, one could also use e.g. carbon fibres, electrically conducting soots or other metal powders such as copper powder or a powder of a copper-based metal alloy.

Using the method according to the invention, an electrically conducting material in the form of particles, especially powders or dusts, is applied to the back of the decorative paper impregnated with an aminoplastic resin before the decorative paper is pressed together with the other layers of the laminate.

The impregnation of the decorative paper, which is done with aminoplastic resins such as e.g. melamine resin in particular, makes it necessary to partially harden the resin in a heating furnace through which the decorative paper is passed. In the context of this method, the electrically conducting particles can be applied before the decorative paper is feed into the heating furnace or—if a two-stage heating furnace is used—onto the pre-hardened resin between the first and second stages. In this case the resin binds with the particles in the second stage of the heating furnace during the partial hardening of the resin. The final hardening takes place later on when the laminate is manufactured in the press in which the sandwich consisting of the decorative paper, possibly with overlay, support and counteracting layer is pressed together at a high temperature and pressure.

It is also conceivable that the electrically conducting particles could be mixed into the impregnating resin before the latter is applied to the decorative paper.

It has been demonstrated that there are no disadvantages involved in embedding electrically conducting particles in the aminoplastic resin mass via the impregnation of the decorative paper. Previous attempts to use conducting melamine resins with additives for the impregnation of the overlay negatively affected moisture absorption or the transparency of the decorative layer, i.e. caused a milky clouding of the surface.

Suitable resins include aminoplastics in particular, above all melamine and phenolic resins.

Preferred embodiments of the invention will now be described in more detail below with reference to the enclosed drawing.

The sole Figure is a perspective view of a laminate according to the invention before pressing takes place.

A laminate according to the invention consists at the core of a support 10, especially a wood-fibre board made from medium or high-density fibreboard material. After pressing, the laminate is cut into individual panels, and a modified groove and tongue profile is milled along the edges of the support, thereby allowing the individual panels to be joined up during the laying process.

On the top side of support 10 there is a decorative paper 12 printed with e.g. a wood-look decor. This decorative paper 12 is impregnated with an aminoplastic synthetic resin, and particles of a conducting material such as e.g. graphite dust or iron filings, are applied to the back of this decorative paper, i.e. to the down-facing side as illustrated in the drawing. This can be done immediately after the synthetic resin is applied to the decorative paper, before starting the pre-hardening of the synthetic resin, which takes place in a heating furnace, or, in a split oven that is interrupted in the direction of transit, between the first and second parts of the pre-hardening process. During this pre-hardening, the synthetic resin is not hardened completely, but remains in a sticky state which subsequently allows it to be pressed together with the support 10.

In many cases, the decorative paper is topped with a transparent, specially made cellulose paper into which corundum particles are woven, or which is impregnated with corundum particles, which give the laminate the desired resistance to wear and tear and the hardness required for long-term use.

Finally, underneath support 10, there is a layer which is referred to in general as the counteracting layer 16, and which prevents support 10 from curling upwards due to any shrinkage in decorative paper 12 after pressing.

It is also possible to apply electrically conducting particles in the sense defined above to the counteracting layer 16. The application of electrically conducting particles to counteracting layer 16 can supplement and reinforce the effect of the above-described application of electrically conducting particles to the decorative paper, but is effective in its own right as a means of reducing voltage build-up.

1. A floor plank, in particular a multi-layer pressed laminate panel with a decorative paper (12) in the top walked-on layer, which is impregnated with an aminoplastic resin or similar, characterized in that particles of an electrically conducting material are applied to the back of decorative paper (12).

2. The floor plank of claim 1, characterized in that the electrically conducting material is iron powder.

3. The floor plank of claim 1, characterized in that the electrically conducting material is a copper powder.

4. The floor plank of claim 1, characterized in that the electrically conducting material is a powder or a copper-based metal alloy.

5. The floor plank of claim 1, characterized in that the electrically conducting material is graphite dust.

6. The floor plank of claim 1, characterized in that the electrically conducting material consists of carbon fibres.

7. The floor plank of claim 1, characterized in that the electrically conducting material is electrically conductive soot.

8. The floor plank of claim 1, characterized in that the aminoplastic resin is a melamine resin.

9. The floor plank according to one of claims 1 to 8, in which, attached to the back of a support, there is a counteracting layer (16) which prevents the support from curling upwards in the event of shrinkage of the decorative paper, characterized in that electrically conducting particles are applied to the counteracting layer (16).

10. A method for manufacturing a floor plank, especially a multi-layer laminate panel pressed in one operation, which, as the top walked-on layer, has a decorative paper (12) impregnated with an aminoplastic resin, characterized in that particles of an electrically conducting material are applied to the back of the decorative paper (12) impregnated with a resin.

11. The method of claim 10, characterized in that the electrically conducting particles are sprinkled onto the fresh, not yet hardened resin.

12. The method of claim 10 or 11, characterized in that the electrically conducting particles consist of graphite dust.

13. The method of claim 10 or 11, characterized in that the electrically conducting particles consist of carbon fibres.

14. The method of claim 10 or 11, characterized in that the electrically conducting particles consist of electrically conductive soot.

15. The method of claim 10 or 11, characterized in that the electrically conducting particles consist of iron powder.

16. The method of claim 10 or 11, characterized in that the electrically conducting particles consist of copper powder.

17. The method of claim 10 or 11, characterized in that the electrically conducting particles consist of the metal powder of a copper alloy.

18. The method of one of claims 10 to 17, characterized in that the electrically conducting particles are applied to the decorative paper (12) before it is fed through a heating furnace.

19. The method of one of claims 10 to 17, characterized in that the electrically conducting particles are applied to the decorative paper (12) between the first and second stations of a two-stage impregnating furnace after the initial pre-hardening of the resin.

20. The method of claim 10, characterized in that the particles of the electrically conducting material are applied in a mixture with the resin to the decorative paper (12).

21. The method of one of claims 10 to 20, characterized in that the resin is a melamine resin.
